(19) United States
(12) Patent Application Publication
(10) Pub. No.: US 2026/0149564 A1
(43) Pub. Date: May 28, 2026

(54) METHOD FOR PROCESSING AN ENCRYPTED DIGITAL CONTENT WITH A DECISION TREE

(71) Applicant: Orange, Issy-les-Moulineaux (FR)

(72) Inventors: Mihail PLESA, Bucharest (RO); Sebastian IRIMIA, Bucharest (RO); Simona DAVID, Bucharest (RO)

(21) Appl. No.: 19/375,894

(22) Filed: Oct. 31, 2025

(30) Foreign Application Priority Data
Nov. 22, 2024 (EP) 24306950.7

(51) Int. Cl. H04L 9/06; H04L 9/00

(52) U.S. Cl. CPC H04L 9/0618; H04L 9/008

(57) ABSTRACT

A method for processing a digital content with a decision tree, including: transmitting a ciphertext to a server; obtaining, from the server, a processed ciphertext function of an encryption of a difference between a third vector equal to a multiplication of the plaintext and a first matrix, and a first vector; decrypting the processed ciphertext; setting elements of the processed plaintext selectively to 1 or 0; encrypting the processed plaintext; transmitting the resulting second ciphertext to the server; obtaining, from the server, a second processed ciphertext function of an encryption of a difference between a fourth vector equal to a multiplication of the processed plaintext and a second matrix, and a second vector; decrypting the second processed ciphertext; setting elements of the resulting second plaintext selectively to 0 or 1; and determining an outcome of the decision tree based on the second plaintext.

### CROSS-REFERENCE TO RELATED APPLICATIONS

This application claims foreign priority to EP24306950.7, filed Nov. 22, 2024, the contents of which are incorporated by reference herein in its entirety.

### BACKGROUND

### Field

The present disclosure generally belongs to the technical field of encryption and decryption of digital content.

More precisely, the present disclosure relates to a method for processing an encrypted digital content with a decision tree.

### Description of the Related Technology

When seeking to process digital content, entities such as companies and individuals (here referred to as “client device”) often rely on third-parties (here referred to as “processing device”), mainly because a client device does not possess the required computational resources and/or the know-how required for the respective processing.

The processing of digital content involves for example image classification, image feature classification or threat classification in Internet traffic.

Decision trees are at the core of many processing data structures. A processing device may have a decision tree exposed to a client device through a service.

However, the client device may not want to reveal the digital content to be processed to the processing device. Furthermore, the processing device may not want to reveal the properties of the decision tree.

There are many current solutions for processing a confidential digital content with a decision tree.

These solutions are based on either fully homomorphic encryption protocols or additive homomorphic encryption protocols in conjunction with privacy-preserving comparison protocols. These solutions evaluate the decision tree node by node.

The known solutions either require many back-and-forth transmissions of encrypted data between the client device and the processing device, and are inefficient due to complex encryption protocols that are required. Thus, these solutions are slow in terms of effective runtime and generate large ciphertexts, which leads to an inflation of the data.

Accordingly, a need exists for a method that responds to at least some of the problems mentioned above, and that allows efficiently processing a confidential digital content with a decision tree, and that requires less back-and-forth transmissions of data between the client device and the processing device.

### SUMMARY

The present disclosure remedies the shortcomings of prior art.

It is disclosed a method for processing a digital content with a decision tree comprising a plurality of nodes and a plurality of leaves, wherein a splitting attribute and a splitting threshold are assigned to each node, the decision tree being defined by a first matrix defining a relation between the nodes and the splitting attributes, a second matrix defining a position of a respective leaf of the decision tree with respect to a respective node of the decision tree, a first vector comprising the splitting threshold of each node, and a second vector describing, for each leaf of the decision tree, a number of successful tests on splitting attributes of respective nodes required to reach a respective leaf.

The method may comprise:
obtaining, by a client device, a plaintext representative of a digital content to be processed, the plaintext being in the form of a vector;
encrypting, by the client device, the plaintext to obtain a ciphertext;
transmitting, by the client device, the ciphertext to a processing device;
obtaining, by the client device, a processed ciphertext from the processing device, the processed ciphertext being function of an encryption of a difference between a third vector and the first vector, wherein an encryption of the third vector is determined based on an encryption of a multiplication of the plaintext and the first matrix;
decrypting, by the client device, the processed ciphertext, to obtain a processed plaintext;
setting, by the client device, elements of the processed plaintext with a positive sign or being equal to 0 to a first value and elements of the processed plaintext with a negative sign to a second value different from the first value;
encrypting, by the client device, the processed plaintext, to obtain a second ciphertext;
transmitting, by the client device, the second ciphertext to the processing device;
obtaining, by the client device, a second processed ciphertext from the processing device, the second processed ciphertext being function of an encryption of a difference between a fourth vector and the second vector, wherein an encryption of the fourth vector is determined based on an encryption of a multiplication of the processed plaintext and the second matrix;
decrypting, by the client device, the second processed ciphertext, to obtain a second plaintext;
setting, by the client device, elements of the second plaintext either to a third value or to a fourth value, as a function of a value of a respective element of the second plaintext;
determining, by the client device, an outcome of the decision tree based on the second plaintext, the outcome being representative of a leaf of the decision tree.

The client device may be any kind of device, such as a computer, capable of exchanging data with a processing device and capable of processing data and of encrypting and decrypting data. The client device may have a specific arrangement and/or specific programming in order to implement the different steps of the method.

The processing device may be any kind of device, such as a computer, capable of exchanging data with a client device and capable of processing data. The processing device may have a specific arrangement and/or a specific programming in order to implement the different steps of the method.

The expression “obtaining, by a client device, a plaintext representative of a digital content to be processed” may mean that the plaintext is determined by the client device, or that the plaintext is sent by another device to the client device and received by the client device.

The digital content may be any kind of data to be processed. For example, the digital content may be a scalar, a vector or a matrix. However, the digital content may even be a higher-dimensional tensor.

For example, the digital content may be an image. The method may then be applied in order to identify a pattern in the image.

The plaintext may be a vector, wherein each element of the vector may characterize the digital content.

The decision tree may be fully characterized by a vector-matrix description as provided by Nakandalam, S., Saur, K., Yu, G., Karanasos, K., Curino, C., Weimer, M. and Interlandi, M., “Taming model serving complexity, performance and cost: A compilation to tensor computations approach, propose a description of the properties of a decision tree using matrices and vector”, 2020.

The decision tree may be a binary decision tree, i.e. two possible paths may emerge from each node.

Each node may represent a test on a splitting attribute (i.e. a test whether a respective condition is true or false?). When evaluating a digital content with the decision tree, an element of the respective ciphertext may be compared to a splitting threshold of a respective node for least some of the nodes of the decision tree.

Therefore, for a binary decision tree, each test on a splitting attribute may have two possible outcomes that may be characterized as “true” or “false”. The “true” path emerging from the node may be chosen if the test on the splitting attribute is true (e.g. 5>1), and the “false” path emerging from the node may be chosen if the test on the splitting attribute is false (e.g. 3<7).

Each leaf represents one out of several possible outcomes of the decision tree.

In the first matrix, each column may be representative of a given node and each row may be representative of a given element of the ciphertext.

In the second matrix, each column may be representative of a given leaf and each row may be representative of a given node.

Each element of the second vector may describe for a respective leaf how often the “true” path needs to be taken in order to reach a respective leaf when starting at the top of the decision tree.

The third vector may be equal to a multiplication of the plaintext and the first matrix.

The fourth vector may be equal to a multiplication of the processed plaintext and the second matrix.

The encryption and decryption as performed by the method may be homomorphic with respect to addition and multiplication, i.e. multiplicative or additive operations performed on a ciphertext will also be present in the respective plaintext after decryption.

The proposed method is innovative in that an encryption protocol is applied to the vector-matrix description of the decision tree.

The proposed method allows efficiently processing a confidential digital content with a decision tree, which is achieved by using a vector-matrix description of the decision tree, wherein all data sent by the client device to the processing device are encrypted.

Thus, the respective ciphertexts may be processed and an outcome of the decision tree may be determined by the client device, without the processing device learning any relevant information about the data provided by the client device or the processed data that the client device obtains from the processing device.

The processing device has no relevant information about the plaintext, the processed plaintext, the second processed plaintext, the second plaintext or the outcome determined by the client device.

Only few back-and-forth transmissions between the client device and the processing device are required. The method is very efficient and fast in effective runtime, and may easily be implemented even if the client device has limited computational resources.

In an embodiment, a permutation may be applied to the processed ciphertext by the processing device and a permutation inverse to the permutation applied to the processed ciphertext may be applied to the second ciphertext by the processing device.

The permutation provides additional confidentiality for the processing device.

Indeed, by permuting elements of the processed ciphertext before transmitting the processed ciphertext to the client device, it is more difficult for the client device to gather any information about the structure and the content of the first matrix and the first vector and hence about the structure of the decision tree.

In an embodiment, a permutation may be applied to the second processed ciphertext by the processing device. The method may comprise:
having set elements of the second plaintext either to a third value or to a fourth value: encrypting, by the client device, the second plaintext;
transmitting, by the client device, the encrypted second plaintext to the processing device;
obtaining, by the client device, an encrypted outcome of the decision tree from the processing device, the encrypted outcome of the decision tree being representative of a leaf of the decision tree determined by the processing device by applying a permutation inverse to the permutation applied to the second processed ciphertext to the encrypted second plaintext, and by determining an encryption of a multiplication between the encrypted second plaintext and a leaf vector, wherein a respective element of the leaf vector is representative of a respective leaf of the decision tree;
decrypting, by the client device, the encrypted outcome of the decision tree to obtain the outcome of the decision tree.

The permutation provides additional confidentiality for the processing device.

Indeed, by permuting elements of the second processed ciphertext before transmitting the second processed ciphertext to the client device, it is more difficult for the client device to gather any information about the structure and the content of the second matrix and the second vector and hence about the structure of the decision tree.

The encryption of a multiplication between the encrypted second plaintext and the leaf vector may be determined according to the following relation:

$$Enc ( {\sum }_{i} {a}_{i} {b}_{i} ) = {\prod }_{i} {Enc ( {a}_{i} )}^{{b}_{i}}$$

wherein aᵢ are elements of the encrypted second plaintext and bᵢ are elements of the leaf vector.

In an embodiment, encryption and decryption may be based on a protocol being homomorphic with respect to addition and multiplication.

A homomorphic encryption is a form of encryption that allows computations (here additions and multiplications) to be performed on a respective ciphertext without having to decrypt the ciphertext therefore. The resulting computations are directly translated into the plaintext. This means that encrypting a respective plaintext, applying a given transformation to the resulting ciphertext and then decrypting the processed ciphertext will lead to the same result as if the transformation had been directly applied to the plaintext.

In an embodiment, the protocol may be a Paillier encryption protocol.

A specific advantage of the Paillier encryption protocol is that it is homomorphic with respect to addition and multiplication.

However, any encryption protocol being homomorphic with respect to addition and multiplication may be used.

In an embodiment, the encryption of a multiplication of the plaintext and the first matrix, and/or the encryption of a multiplication of the processed plaintext and the second matrix may be defined as:

$$Enc ( {\sum }_{i} {a}_{i} {b}_{ij} ) = {\prod }_{i} {Enc ( {a}_{i} )}^{{b}_{ij}}$$

wherein aᵢ are elements of the plaintext/the processed plaintext and bᵢⱼ are elements of the first matrix/the second matrix.

This formula may be specific to Paillier encryption. However, similar relations allowing to determine the encrypted product between vectors and/or matrices may be used for other encryption protocols being homomorphic with respect to addition and multiplication.

Starting from an encrypted vector Enc(mᵢ) and a matrix pᵢⱼ that is not encrypted, it is possible to determined the encrypted product of the vector mᵢ and the matrix pᵢⱼ.

Thus, the processing device can perform multiplicative operations on the ciphertext provided by the client device without learning any relevant information about the underlying plaintext.

In an embodiment, the encryption of a difference between the third vector and the first vector and/or an encryption of a difference between the fourth vector and the second vector may be defined as:

$$Enc ( {r}_{i} \times ( {c}_{i} - {d}_{i} ) ) = {( Enc ( {c}_{i} ) \times {Enc ( {d}_{i} )}^{- 1} )}^{{r}_{i}}$$

wherein cᵢ are elements of the third vector/the fourth vector, dᵢ are elements of the first vector/the second vector, and rᵢ are numbers having a same sign.

In an embodiment, rᵢ may be positive numbers.

In an embodiment, rᵢ may be random numbers.

In an embodiment, the encryption of a difference between the third vector and the first vector and/or an encryption of a difference between the fourth vector and the second vector may be defined as:

$$Enc ( {c}_{i} - {d}_{i} ) = Enc ( {c}_{i} ) \times {Enc ( {d}_{i} )}^{- 1}$$

This formular may be specific to Paillier encryption. However, similar relations allowing to determine the encrypted difference between vectors and/or matrices may be used for other encryption protocols being homomorphic with respect to addition and multiplication.

Thus, starting from an encrypted vector Enc(qᵢ) and an encrypted vector Enc(pᵢ), it is possible to determine the encrypted difference of the vector qᵢ and the vector pᵢ.

Thus, the processing device can perform subtractive operations on the ciphertext provided by the client device without learning any relevant information about the underlying plaintext.

As mentioned, the client device may only be interested in the sign of each element of the difference qᵢ-pᵢ. Thus, the processing device may multiply each element of the difference qᵢ−pᵢ with an individual factor rᵢ. Like this, the client device cannot learn any relevant information about the elements of the difference qᵢ-pᵢ except for the sign which is preserved if only factors rᵢ having a same sign are used.

In an embodiment, setting, by the client device, elements of the processed plaintext with a positive sign or being equal to 0 to a first value and with a negative sign to a second value may comprise: setting elements of the processed plaintext to 1 if a difference between respective elements the third vector and the first vector is positive or equal to 0 and to 0 if a difference between respective elements of the third vector and the first vector is negative.

In an embodiment, setting, by the client device, elements of the second plaintext either to a third value or to a fourth value, as a function of a value of a respective element, may comprise: setting elements with a value different from 0 to 0 and elements with a value equal to 0 to 1.

In an embodiment, a respective element of the first matrix may be equal to 1 if a respective splitting attribute is assigned to a respective node and equal to 0 if a respective splitting attribute is not assigned to a respective node.

In an embodiment, each element of the second matrix may be representative of a position of respective leaf with respect to a respective node of the decision tree, and each element of the second matrix may have a fifth value if a successful test of the splitting attribute of a respective node is required in order to reach the respective leaf, a sixth value if an unsuccessful test of the splitting attribute of the respective node is required in order to reach the respective leaf, and a seventh value it a respective leaf cannot be reached from a respective node.

In an embodiment, the fifth value may be equal to 1, the sixth value may be equal to −1 and the seventh value may be equal to zero.

Each element of the second matrix may indicate whether from a respective node the “true” path or the “false” path has to be taken in order to reach a respective leaf. When the “true” path has to be taken, the value of the element may be 1 (fifth value), when the false path has to be taken, the value of the element may be −1 (sixth value), and if it is not possible to reach the respective leaf from the respective node, the value of the element may be 0 (seventh value).

Another aspect of the present disclosure is related to a computer program product comprising instructions which, when the instructions are executed by a processing unit, cause the processing unit to implement the method as described above.

This program may use any programming language (for example, an object-oriented language or other), and be in the form of interpretable source code, partially compiled code, or fully compiled code.

Another aspect of the present disclosure is related to a client device configured to process a digital content with a decision tree comprising a plurality of nodes and a plurality of leaves, wherein a splitting attribute and a splitting threshold are assigned to each node, the decision tree being defined by a first matrix defining a relation between the nodes and the splitting attributes, a second matrix defining a position of a respective leaf of the decision tree with respect to a respective node of the decision tree, a first vector comprising the splitting threshold of each node, and a second vector describing, for each leaf of the decision tree, a number of successful tests on splitting attributes of respective nodes required to reach a respective leaf.

The client device may comprise:
an interface configured to obtain a plaintext representative of a digital content to be processed, the plaintext being in the form of a vector;
a circuit configured to encrypt the plaintext to obtain a ciphertext;
an interface configured to transmit the ciphertext to the processing device;
an interface configured to obtain a processed ciphertext from the processing device, the processed ciphertext being function of an encryption of a difference between a third vector and the first vector, wherein an encryption of the third vector is determined based on an encryption of a multiplication of the plaintext and the first matrix;
a circuit configured to decrypt the processed ciphertext, to obtain a processed plaintext;
a circuit configured to set elements of the processed plaintext with a positive sign or being equal to 0 to a first value and elements of the processed plaintext with a negative sign to a second value different from the first value;
a circuit configured to encrypt the processed plaintext, to obtain a second ciphertext;
an interface configured to transmit the second ciphertext to the processing device;
an interface configured to obtain a second processed ciphertext from the processing device, the second processed ciphertext being function of an encryption of a difference between a fourth vector and the second vector, wherein an encryption of the fourth vector is determined based on an encryption of a multiplication of the processed plaintext and the second matrix;
a circuit configured to decrypt the second processed ciphertext, to obtain a second plaintext;
a circuit configured to set elements of the second plaintext either to a third value or to a fourth value, as a function of a value of a respective element of the second plaintext;
a circuit configured to determine an outcome of the decision tree based on the second plaintext, the outcome being representative of a leaf of the decision tree.

Another aspect of the present disclosure is related to a processing device configured to process a digital content with a decision tree comprising a plurality of nodes and a plurality of leaves, wherein a splitting attribute and a splitting threshold are assigned to each node, the decision tree being defined by a first matrix defining a relation between the nodes and the splitting attributes, a second matrix defining a position of a respective leaf of the decision tree with respect to a respective node of the decision tree, a first vector comprising the splitting threshold of each node, and a second vector describing, for each leaf of the decision tree, a number of successful tests on splitting attributes of respective nodes required to reach a respective leaf.

The processing device may comprise:
an interface configured to receive a ciphertext from the client device, the ciphertext being determined by the client device by encrypting a plaintext, the plaintext being representative of a digital content to be processed, the plaintext being in the form of a vector;
a circuit configured to determine an encryption of a third vector equal to an encryption of a multiplication of the plaintext and the first matrix;
a circuit configured to determine a processed ciphertext function of an encryption of a difference between the third vector and the first vector;
an interface configured to transmit the processed ciphertext to the client device;
an interface configured to receive a second ciphertext from the client device, the second ciphertext being determined by the client device by decrypting the processed ciphertext to obtain a processed plaintext, by setting elements of the processed plaintext with a positive sign or being equal to 0 to a first value and elements of the processed plaintext with a negative sign to a second value different from the first value, and by encrypting the processed plaintext;
a circuit configured to determine an encryption of a fourth vector based on an encryption of a multiplication of the processed plaintext and the second matrix;
a circuit configured to determine a second processed ciphertext function of an encryption of a difference between a fourth vector and the second vector;
an interface configured to transmit the second processed ciphertext to the client device, in order for the client device to decrypt the second processed ciphertext to obtain a second plaintext, to set elements of the second plaintext either to a third value or to a fourth value, as a function of a value of a respective element of the second plaintext, and to determine an outcome of the decision tree based on the second plaintext, the outcome being representative of a leaf of the decision tree.

Another aspect of the present disclosure is related to a system comprising a client device as described above and a processing device as described above.

The client device and the processing device may be for example a computer.

The client device and the processing device may communicate with each other over any communication channel (private or public), for example via Internet.

The system may be configured to implement the method described above.

The proposed system is innovative in that an encryption protocol is applied to the vector-matrix description of the decision tree.

The proposed system allows efficiently processing a confidential digital content with a decision tree, which is achieved by using a vector-matrix description of the decision tree, wherein all data sent by the client device to the processing device are encrypted by the client device.

Thus, the digital content may be processed and an outcome of the decision tree may be determined by the client device, without the processing device learning any relevant information about the data provided by the client device or the processed data that the client device obtains from the processing device.

The processing device has no relevant information about the plaintext, the processed plaintext, the second processed plaintext, the second plaintext of the lead determined by the client device.

Only few back-and-forth transmissions between the client device and the processing device are required. The method is very efficient and fast in effective runtime, and may easily be implemented even if the client device has limited computational resources.

The system is very efficient and fast in effective runtime. The system may easily implement the method even if the client device has limited computational resources.

### BRIEF DESCRIPTION OF THE DRAWINGS

Other features, details and advantages will be shown in the following detailed description and on the figures, on which:

FIG. 1 shows an arrangement of a system comprising a client device and a processing device according to the present disclosure.

FIG. 2 shows an embodiment of a decision tree for which a method for processing a digital content with a decision tree according to the present disclosure may be implemented.

FIG. 3 shows a flow chart of a method for processing a digital content with a decision tree.

FIG. 4 shows an embodiment of a client device/a processing device according to the present disclosure.

### DETAILED DESCRIPTION OF CERTAIN ILLUSTRATIVE EMBODIMENTS

In the following, a method for processing a digital content with a decision tree is presented. The method may be implemented according to several embodiments.

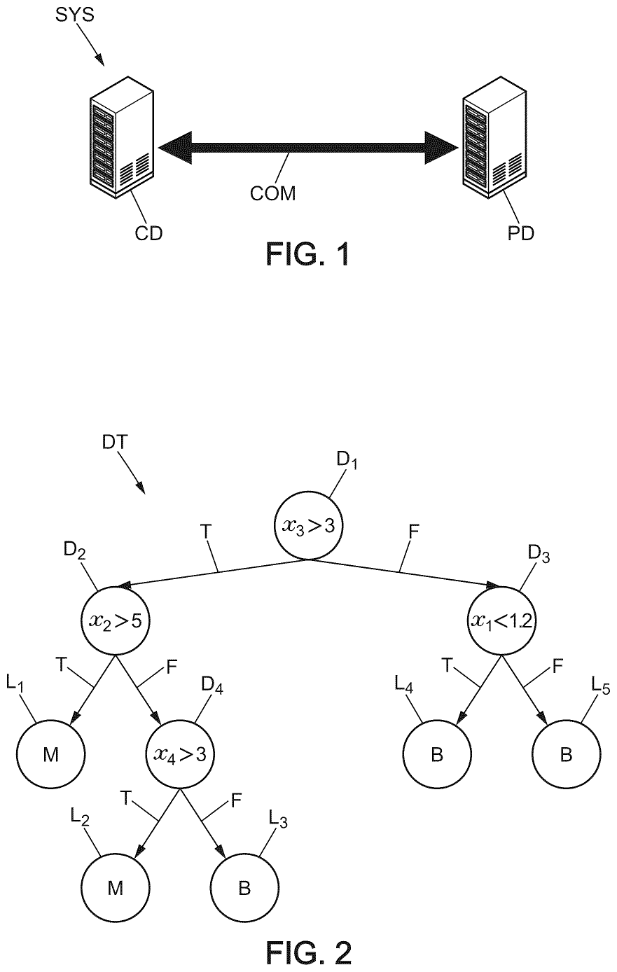

FIG. 1 shows a possible arrangement of a system SYS by which the method may be implemented.

The system SYS comprises a client device CD and a processing device PD that may communicate with each other over a communication channel COM such as the Internet.

For example, the client device CD and the processing device PD may each be a server.

The client device CD may determine a digital content to be processed, for example an image to be analyzed, but not dispose of the required resources for processing the digital content. Therefore, the client device CD may rely on a processing device PD that disposes of a decision tree for processing at least partially the digital content.

The digital content may be confidential and the client device CD may not want to reveal the digital content to the processing device PD or any other third-party.

In addition, the processing device PD may not want to reveal the main properties of the decision tree.

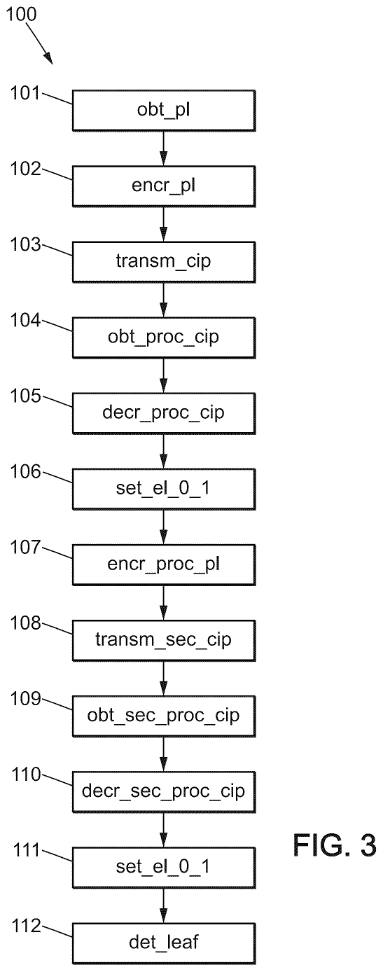

The method 100 for processing a digital content with a decision tree according to the present application that will be presented in relation to FIG. 3 may ensure confidentiality of both the digital content and the main properties of the decision tree by using a vector-matrix description of the decision tree and by implementing several back-and-forth transmission of encrypted content between the client device CD and the processing device PD.

FIG. 2 illustrates the general concept of a decision tree DT. Here, a binary decision tree is considered.

In this example, the decision tree DT comprises four nodes D₁, D₂, D₃, D₄ and five leaves L₁, L₂, L₃, L₄, L₅.

Each node D₁, D₂, D₃, D₄ is characterized by a splitting attribute x₁, x₂, x₃, x₄ and a splitting threshold.

At each node D₁, D₂, D₃, D₄, it may be evaluated whether a respective condition is true of false. If the condition is false, the “false” path (F in FIG. 2) emerging from the respective node D₁, D₂, D₃, D₄ is chosen to proceed further. If the condition is true, the “true” path (T in FIG. 2) emerging from the respective node D₁, D₂, D₃, D₄ is chosen to processed further.

Each leaf L₁, L₂, L₃, L₄, L₅ may correspond to a possible outcome of the decision tree DT from which no further path emerges.

A plaintext x={x₁, x₂, . . . , xₙ}={1.5, 2, 3.5, 5, 4} representative of the digital content to be evaluated by the decision tree DT may be considered.

For example, if the digital content is an image, the elements of the vector x may be representative of specific properties of the image.

In another example, if the digital content is related Internet activities by users, the elements of the vector x may be representative of specific properties of the Internet activities, such as the number of emails sent or the number of files opened.

The decision tree DT is evaluated starting from the top, i.e. by evaluating the first node D₁.

The splitting attribute of the first node D₁ is x₃, and the splitting threshold is 3. At the first node D₁, it is evaluated whether x₃>3.

As the third element x₃ of the plaintext x has the value 3.5 and since 3.5>3, the condition is true and the path to which the label “true” is assigned is chosen.

Therefore, the next node to be evaluated is the second node D₂, the condition of this node being x₂>5. The second value x₂ of the plaintext x being 2, the condition 2>5 is false and therefore the path to which the label “false” is assigned is chosen.

Therefore, the next node to be evaluated is the fourth node D₄, the condition of this node being x₄>3. The fourth value x₄ of the vector x being 5, the condition 5>3 is true and therefore the path to which the label “true” is assigned is chosen.

Therefore, the evaluation of the decision tree DT ends on the second leaf L₂ which is considered as the outcome of the decision tree for plaintext x.

In the above-mentioned example regarding Internet activities of users, x₁ may be representative of the number of emails sent, x₂ may be representative of the number of files opened, x₃ may be the mean size of attachments, and x₄ may be representative of the number of words in visited websites.

Each leaf L₁, L₂, L₃, L₄, L₅ may characterize the digital content, which may be either “malicious” (M in FIG. 2) or “benign” (B in FIG. 2).

Since in the example considered above the leaf L₂ is characterized as malicious, the outcome of the decision tree for the considered digital content is that the digital content is malicious.

Instead of evaluating a decision tree DT step by step as explained above, a decision tree DT may be fully characterized by a vector-matrix description and be evaluated in this vector-matrix description.

Such a matrix-vector-description is provided by Nakandalam, S., Saur, K., Yu, G., Karanasos, K., Curino, C., Weimer, M. and Interlandi, M., “Taming model serving complexity, performance and cost: A compilation to tensor computations approach, propose a description of the properties of a decision tree using matrices and vector”, 2020.

Two matrices and three vectors may be defined in order to fully describe the decision tree DT:
a first matrix defining a relation between the nodes D₁, D₂, D₃, D₄ and the splitting attributes x₁, x₂, x₃, x₄;
a second matrix defining a position of a respective leaf L₁, L₂, L₃, L₄, L₅ of the decision tree DT with respect to a respective node D₁, D₂, D₃, D₄ of the decision tree DT;
a first vector comprising the splitting threshold of each node D₁, D₂, D₃, D₄;
a second vector describing, for each leaf L₁, L₂, L₃, L₄, L₅ of the decision tree DT, a number of successful tests on splitting attributes of respective nodes D₁, D₂, D₃, D₄ required to reach a respective leaf L₁, L₂, L₃, L₄, L₅ starting from the top node D₁; and
a leaf vector, wherein a respective element of the leaf vector is representative of a respective leaf L₁, L₂, L₃, L₄, L₅ of the decision tree DT.

More precisely, the decision tree DT may be described as follows:
define a first matrix A with n lines and d columns:

$$A [ i ] [ j ] = \{ \begin{matrix}1 , if {x}_{i} is the splitting attribute of node {D}_{j} \\ 0 , otherwise\end{matrix}$$

$$1 \leq i \leq n , 1 \leq j \leq d$$

define a first vector B with d elements. B[j] represents the splitting threshold for the node Dⱼ;
define a second matrix C with d lines and m columns:

$$C [ j ] [ k ] = \{ \begin{matrix}1 , if a “ true ” path emerging from {D}_{j} is chosen in order to reach leaf {L}_{k} \\ - 1 , if a “ false ” path emerging from {D}_{j} is chosen in order to reach leaf {L}_{k} \\ 0 , if a leaf {L}_{k} cannot be reached from a node {D}_{j}\end{matrix}$$

$$1 \leq j \leq d , 1 \leq k \leq m$$

define a second vector D with m elements. D[k] counts how many “true” paths were chosen in the path from the root, i.e. from node D₁, to leaf Lk. Since in FIG. 2 the “true” paths always go to the left and the “false” subtrees go to the right, D[k] counts in this configuration the number of left subtrees;
define a leaf vector L={L₁, L₂, L₃, L₄, L₅}.

Regarding the evaluation of a plaintext x with the decision tree DT in the vector-matrix description, it is proceeded as follows:
compute the vector x×A and compare it to the first vector B:

$$p [ j ] = \{ \begin{matrix}1 , ( x \times A ) [ j ] \geq B [ j ] \\ 0 , otherwise\end{matrix}$$

$$1 \leq j \leq d$$

compute the vector p×C and compare it to the second vector D:

$$y [ j ] = \{ \begin{matrix}1 , ( p \times C ) [ k ] \geq D [ j ] \\ 0 , otherwise\end{matrix}$$

$$1 \leq k \leq m$$

compute the inner product between the vector y and the leaf vector.

The evaluation of a decision tree DT in the vector-matrix formulation is now illustrated for the example of FIG. 2.

A first matrix

$$A = ( \begin{matrix}0 & 0 & 1 & 0 \\ 0 & 1 & 0 & 0 \\ 1 & 0 & 0 & 0 \\ 0 & 0 & 0 & 1 \\ 0 & 0 & 0 & 0\end{matrix} )$$

may be defined that characterizes the relation between a respective node D₁, D₂, D₃, D₄ and a respective splitting attribute.

Each column of the first matrix is representative of a given node D₁, D₂, D₃, D₄ and each row is representative of a given splitting attribute of the plaintext x. Since in the above-mentioned example the decision tree DT has four nodes D₁, D₂, D₃, D₄ and the plaintext comprises five elements x₁, x₂, x₃, x₄ x₅, the first matrix A has five rows and four columns.

For example, the element (1,1) of the first matrix A is 0, which means that the splitting attribute x₁ is not assigned to node D₁. The element (1,3) of the first matrix A is 1, which means that the splitting attribute x₃ is assigned to node D₁.

The plaintext x=(1.5, 2, 3.5, 5, 4) that the client device CD wants to process has elements which are arranged in increasing order of the indices of the splitting attributes, i.e. x=(x₁, x₂, x₃, x₄, x₅).

When multiplying m=x×A (referred to as third vector), the resulting vector m comprises the elements of the plaintext x, but now arranged according to the indices of the nodes D₁, D₂, D₃, D₄ rather than according to the indices of the aplitting attributes.

In the example mentioned above, calculating x×A yields m=(3.5, 2, 1.5, 5). This means that the first element 3.5 of the vector m is to be evaluated by the first node D₁, the second element of the vector m is evaluated by the second node D₂, the third element of the vector m is evaluated by the third node D₃, and the fourth element of the vector m is evaluated by the fourth node D₄.

The values of the vector m are then compared to a first vector B whose elements correspond to the splitting thresholds of the nodes D₁, D₂, D₃, D₄, wherein the first element of the first vector B corresponds to the splitting threshold of the first node D₁, the second element of first vector B corresponds to the splitting threshold of the second node D₂, etc.

Thus, the first vector B can be written as B=(3, 5, 1.2, 3).

A vector p may be defined to store the result of this comparison. Each element j of the vector p may have a value of 1 if m[j]≥B[j] and be equal to 0 otherwise.

The resulting vector p is therefore p=(1, 0, 1, 1).

A second matrix C may be defined, wherein each column of the second matrix C is representative of a given leaf and each row is representative of a given node D₁, D₂, D₃, D₄. Since in the above-mentioned example the decision tree DT has four nodes D₁, D₂, D₃, D₄ and five leaves L₁, L₂, L₃, L₄, L₅, the second matrix C has four rows and five columns.

Each element of the second matrix C indicates whether from a respective node D₁, D₂, D₃, D₄ the “true” path or the “false” path has to be taken in order to reach a respective leaf L₁, L₂, L₃, L₄, L₅. When the “true” path has to be taken, the value of the element is 1 (referred to as fifth value), when the false path has to be taken, the value of the element is −1 (referred to as sixth value), and if it is not possible to reach the respective leaf L₁, L₂, L₃, L₄, L₅ from the respective node D₁, D₂, D₃, D₄, the value of the element is 0 (referred to as seventh value).

$$C = ( \begin{matrix}1 & 1 & 1 & - 1 & - 1 \\ 1 & - 1 & - 1 & 0 & 0 \\ 0 & 0 & 0 & 1 & - 1 \\ 0 & 1 & - 1 & 0 & 0\end{matrix} )$$

For example, the element (1,1) of the second matrix C is representative of the first node D₁ and the first leaf L₁. It can be seen that starting from node D₁, the path “true” has to be taken in order be able to reach leaf L₁. The value of element (1,1) of the second matrix C is therefore equal to 1.

For example, the element (2,2) of the second matrix C is representative of the second node D₂ and the second leaf L₂. It can be seen that starting from node D₂, the path “false” has to be taken in order be able to reach leaf L₂. The value of element (2,2) of the second matrix C is therefore equal to −1.

For example, the element (3,3) of the second matrix C is representative of the third node D₃ and the third leaf L₃. It can be seen that starting from node D₃, it is not possible to reach leaf L₃, since leaf L₃ is not downstream of D₃. The value of element (3,3) of the second matrix C is therefore equal to 0.

The vector p determined previously and the second matrix C may now be multiplied: p×C. The result of this multiplication is referred to as q (called fourth vector).

The obtained result is q=(1, 2, 0, 0, −2).

The vector q may then be compared to a second vector D.

Each element of the second vector D is representative of a number of successful tests on splitting attributes of respective nodes D₁, D₂, D₃, D₄ required to reach a respective leaf L₁, L₂, L₃, L₄, L₅, i.e. the number of times a “true” path has to be taken in order to reach a respective leaf L₁, L₂, L₃, L₄, L₅ when starting at the top of the decision tree DT, i.e. at node D₁.

For example, in order to reach leaf L₁ starting from D₁, two “true” paths have to be taken, and therefore the value of the first element of the second matrix D is 2.

For example, in order to reach leaf L₃ starting from D₁, one “true” path and two “false” paths have to be taken. Since only the number of true paths are considered and the number of false paths are neglected, the value of the third element of the second matrix D is 1.

For example, in order to reach leaf L₅ starting from D₁, two “false” paths have to be taken. Since no true path has to be taken, the value of the fifth element of the second matrix D is 0.

The second vector D is therefore D=(2, 2, 1, 1, 0).

Regarding the comparison of q and D, it is determined whether a respective element of q is equal to a respective element of D. This means that the first element of q is compared to the first element of D, the second element of q is compared to the second element of D, etc.

Only the second element of q is equal to the second element of D, all other respective elements are different from each other.

The vector y stores the result of this comparison. When the respective elements are equal, the respective element of y is set to 1, otherwise the element is set to 0.

Therefore, all elements of the vector y are equal to 0 except for the second element which is equal to 1: y=(0, 1, 0, 0, 0).

The vector y may then be multiplied to a leaf vector L=(L₁, L₂, L₃, L₄, L₅). The outcome is L₂, and therefore the outcome of the evaluation of the decision tree DT is the second leaf L₂, i.e., the digital content is identified to be malicious.

As mentioned earlier, the client device CD does not want to reveal any relevant information regarding the plaintext or the outcome of the decision tree to the processing device PD. Similarly, the processing device PD does not want to reveal any relevant information regarding the decision tree DT to the client device CD.

In order to keep the plaintext x and the outcome of the decision tree L₂ and further the properties of the decision tree DT confidential, the method 100 described in relation to FIG. 3 is proposed.

In the method 100, a vector-matrix description of the decision tree DT as presented above is used.

In order be able to perform encryption and decryption, the client device CD has access to an encryption protocol being homomorphic with respect to addition and multiplication.

Any encryption protocol being homomorphic with respect to addition and multiplication can be used.

Homomorphism with respect to addition may be defined as:
Enc(a₁)⊕Enc(a₂)=Enc(a₁+a₂), where ⊕ is the operation performed over the ciphertext space, i.e. for ciphertexts Enc(a₁) and Enc(a₂), and + is the operation performed over the plaintext space, i.e. for plaintexts a₁ and a₂.

By way of example, the Paillier encryption protocol is considered.

In the Paillier encryption protocol, the expression Enc(a₁)⊕Enc(a₂) becomes:

$$Enc ( {a}_{1} ) ⊕ Enc ( {a}_{2} ) = Enc ( {a}_{1} ) \times Enc ( {a}_{2} ) mod {n}^{2} = Enc ( {a}_{1} + {a}_{2} mod n )$$

where × corresponds to a multiplication and + corresponds to an addition.

Simply speaking, in the Paillier encryption protocol, the operation ⊕ is a multiplication modulo n² and the operation+is an addition modulo n.

In another example, the EIGamal encryption protocol may be considered.

In the EIGamal encryption protocol, the expression Enc(a₁)⊕Enc(a₂) becomes:

$$Enc ( {a}_{1} ) ⊕ Enc ( {a}_{2} ) = Enc ( {g}^{{a}_{1}} ) \times Enc ( {g}^{{a}_{2}} ) = Enc ( {g}^{{a}_{1} + {a}_{2}} )$$

Homomorphism with respect to multiplication may be defined as:
Enc(a₁)⊗Enc(a₂)=Enc(a₁×a₂), where ⊗ is the operation performed over the ciphertext space, i.e. for ciphertexts Enc(a₁) and Enc(a₂), and × is the operation performed over the plaintext space, i.e. for plaintexts a₁ and a₂.

By way of example, the Paillier encryption protocol is considered.

For the Paillier encryption protocol, the expression Enc(a₁)⊗Enc(a₂) becomes:

$$Enc ( {a}_{1} ) ⊗ Enc ( {a}_{2} ) = {Enc ( {a}_{1} )}^{{a}_{2}} mod {n}^{2} = Enc ( {a}_{1} \times {a}_{2} mod n ) .$$

In another example, the EIGamal encryption protocol may be considered.

In the EIGamal encryption protocol, the expression Enc(a₁)⊗Enc(a₂) becomes:

$$Enc ( {a}_{1} ) ⊗ Enc ( {a}_{2} ) = Enc ( {a}_{1} ) \times {a}_{2} = Enc ( {a}_{1} \times {a}_{2} ) .$$

Hereafter, the method of the present application is illustrated for the specific example of the Paillier encryption. However, other encryption protocols being homomorphic with respect to addition and multiplication may be applied instead.

The following relations may be deduced from the above-mentioned relations for the Paillier encryption.

The encryption of a multiplication of a plaintext vector aᵢ and a plaintext matrix bᵢⱼ may be expressed as: Enc(Σᵢaᵢ×bᵢⱼ)=Πᵢ Enc(aᵢ)^{b}^{ᵢⱼ}.

Similarly, the encryption of a multiplication of a plaintext vector aᵢ and another plaintext vector bᵢ may be determined as: Enc(Σᵢaᵢ×bᵢ)=Πᵢ Enc(aᵢ)^{b}^{ᵢ}.

When having a plaintext vector a=(a₁, a₂, . . . , aₙ) and a ciphertext vector c=Enc(b)=(Enc(b₁), Enc(b₂), . . . , Enc(bₙ)), it is possible to determine Enc(a×b) by the following relation:

$$Enc ( a x b ) = {Enc ( {a}_{1} )}^{{b}_{1}} \times {Enc ( {a}_{2} )}^{{b}_{2}} \times ... \times {Enc ( {a}_{n} )}^{{b}_{n}} \qquad ( equ . 1 )$$

When having a plaintext matrix b with elements bᵢⱼ and a ciphertext vector Enc(a)=(Enc(a₁), Enc(a₂), . . . , Enc(aₙ)), it is possible to determine Enc(b×a) by the following relation:

$$Enc ( {( b x a )}_{j} ) = {Enc ( {b}_{1} )}^{{a}_{1 j}} \times {Enc ( {b}_{2} )}^{{a}_{2 j}} \times ... \times {Enc ( {b}_{n} )}^{{a}_{n j}} \qquad ( equ . 2 )$$

When having a plaintext vector c=(cᵢ, c₂, . . . , cₙ) and a ciphertext vector Enc(d)=(Enc(d₁), Enc(d₂), . . . , Enc(dₙ)), it is possible to determine Enc(d−c) by applying the following relation:

$$Enc ( d - c ) = Enc ( {d}_{1} ) \times {Enc ( {c}_{1} )}^{- 1} , Enc ( {d}_{2} ) \times {Enc ( {c}_{2} )}^{- 1} , ... , Enc ( {d}_{n} ) \times {Enc ( {c}_{n} )}^{- 1} ) \qquad ( equ . 3 )$$

In addition, the following relation holds:

$$Enc ( r \times ( d - c ) ) = ( {( Enc ( {d}_{1} ) \times Enc {( {c}_{1} )}^{- 1} )}^{{r}_{1}} , {( Enc ( {d}_{2} ) \times Enc {( {c}_{2} )}^{- 1} )}^{{r}_{2}} , … , {( Enc ( {d}_{n} ) \times {Enc ( {c}_{n} )}^{- 1} )}^{{r}_{n}} ) \qquad ( equ . 4 )$$

where rᵢ may be positive random numbers corresponding to elements of vector r.

Similar relations hold for other encryption protocols.

In the method 100, the client device CD may obtain (step 101) the plaintext x={x₁, x₂, . . . , xₙ} to be processed.

The client device CD may then encrypt (step 102) the plaintext x and transmit (step 103) the resulting ciphertext Enc(x), to the processing device PD. The encryption may be performed by using an encryption protocol being homomorphic with respect to addition and multiplications.

The processing device PD may determine, based on the ciphertext Enc(x) and the first matrix A, the encryption of the product x×A, i.e. Enc(x×A)=Enc(m), by applying equ. 2. Here, x×A has been renamed m (referred to as third vector). Thus, the processing device PD can determine Enc(x×A) without revealing the first matrix A to the client device CD and without knowing the plaintext x.

Then, the comparison between the vector m and the first vector B is performed, which is done by calculating the encryption of the difference m−B, i.e. Enc(m−B) (referred to as processed ciphertext) by applying equ. 3.

Enc(B) is needed as an input of equ. 3. Therefore, starting from the first vector B, it is possible to determine Enc(B) by public-key cryptography. Indeed, most protocols being homomorphic with respect to addition and multiplication can be used for public-key cryptography. The processing device PD can easily determine Enc(B) from a public key of the client device without revealing B to the client device CD and without learning relevant details about the encryption applied by the client device CD.

Having determined Enc(B), Enc(m−B) may be determined based on Enc(m) and Enc(B) by applying equ. 3.

In addition, a positive random number rᵢ may be multiplied to each element of the processed ciphertext, by applying equ. 4: (Enc(rᵢ×(m−B))=Enc(p). Here, rᵢ×(m−B) has been renamed p.

Furthermore, a random permutation may be applied to the elements of the processed ciphertext Enc(rᵢ×(m−B)).

The processed ciphertext Enc(rᵢ×(m−B)) may then be transmitted by the processing device PD to the client device CD.

The client device CD may obtain (step 104) the processed ciphertext Enc(rᵢ×(m−B)) from the processing device PD, and decrypt (step 105) the processed ciphertext Enc(rᵢ×(m−B)), to obtain a processed plaintext rᵢ×(m−B).

The client device CD may set (step 106) elements of the processed plaintext rᵢ×(m−B) with a positive sign or being equal to 0 to 1 (referred to as first value) and elements of the processed plaintext with a negative sign to 0 (referred to as second value).

Since the client device CD is only interested in the signs of the elements of the processed plaintext rᵢ×(m−B), the presence of the positive random numbers rᵢ does not influence on which elements are set to 0 or 1 by the client device CD.

However, the presence of the random numbers rᵢ and the fact that a permutation has been applied by the processing device PD to the processed ciphertext Enc(rᵢ×(m−B)) makes it much more difficult or even impossible for the client device CD to learn any information about the first matrix A or the first vector B. Thus, confidentiality of the properties of the decision tree is ensured.

The client device CD may then encrypt (step 107) the processed plaintext, to obtain a second ciphertext, and transmit (step 108) the second ciphertext to the processing device PD.

The processing device PD may reverse the permutation by applying to the second ciphertext a permutation inverse to the permutation previously applied to the processed ciphertext.

The processing device PD may then determine, based on the second ciphertext Enc(p) and the second matrix C, the encryption of the product p×C, i.e. Enc(p×C)=Enc(q), by applying equ. 2. Here, p×C has been renamed q (called fourth vector).

Thus, the processing device PD is able to determine Enc(p×C) without revealing the second matrix C to the client device CD and without gaining knowledge about the processed plaintext p.

Then, the encryption of the difference q−D is determined, i.e. Enc(q−D), by applying equ. 3. Enc(q−D) is referred to as second processed ciphertext.

Starting from the second vector D, it is possible to determine Enc(D) by public-key cryptography, as explained above.

The processing device PD may further process the second process ciphertext Enc(q−D) based on equ. 4 in order to obtain Enc(rᵢ×(q−D)), where rᵢ may be random positive numbers. Each element of q−D, may be multiplied by an individual random positive number.

In addition, the processing device PD may apply a random permutation to the second processed ciphertext, and then transmit the second processed ciphertext to the client device CD.

The client device CD may obtain (step 109) the second processed ciphertext from the processing device PD and decrypt (step 110) the second processed ciphertext, to obtain a second plaintext.

The client device CD may then set (step 111) elements of the second plaintext to 1 (referred to as third value) if a respective element of the second plaintext is equal to a respective element of the second vector D (i.e. if the difference between both elements is 0) and equal to 0 (referred to as fourth value) otherwise.

Since the client device CD is only interested in the fact if the difference between respective elements is equal to 0 or not, the presence of the positive random numbers rᵢ does not influence on which elements are set to 0 or 1 by the client device CD.

However, the presence of rᵢ and the fact that the permutation has been carried out by the processing device PD on the second processed ciphertext makes sure that the client device CD cannot learn any information about the second matrix B or the second vector D.

The client device CD may then encrypt the second plaintext and transmit the encrypted second plaintext to the processing device PD.

The processing device PD may apply to the encrypted second plaintext a permutation inverse to the permutation applied to the second processed ciphertext to obtain a processed encrypted second plaintext. Like this, the original order of the elements is recovered.

Then, the processing device PD may multiply the processed encrypted second plaintext and the leaf vector by applying equ. 1 to obtain en encrypted outcome of the decision tree DT.

The processing device PD may transmit the encrypted outcome of the decision tree DT to the client device CD.

The client device CD may receive the encrypted outcome of the decision tree DT and decrypt it to determine (step 112) the outcome of the decision tree DT.

The implementation of the method 100 of FIG. 3 is now illustrated for the example of the decision tree DT of FIG. 2.

The client device CD may obtain (step 101) a plaintext x=(1.5, 2, 3.5, 5, 4) and encrypt (step 102) the plaintext to obtain a ciphertext:

$$Enc ( x ) = Enc ( 1.5 , 2 , 3.5 , 5 , 4 ) = ( Enc ( 1.5 ) , Enc ( 2 ) , Enc ( 3.5 ) , Enc ( 5 ) , Enc ( 4 ) ) .$$

The client device CD may then transmit (step 103) the ciphertext to the processing device PD.

The processing device PD may determine, based on the ciphertext Enc(x) and the first matrix A, the encryption of the product x×A, i.e. Enc(x×A)=Enc(m) (where ms is referred to as third vector), by applying equ. 2:

$$Enc ( {m}_{1} ) = Enc {( 1.5 )}^{0} + Enc {( 2 )}^{0} + Enc {( 3.5 )}^{1} + Enc {( 5 )}^{0} + Enc {( 4 )}^{0} = Enc ( 3.5 )$$

$$Enc ( {m}_{2} ) = Enc {( 1.5 )}^{0} + Enc {( 2 )}^{1} + Enc {( 3.5 )}^{0} + Enc {( 5 )}^{0} + Enc {( 4 )}^{0} = Enc ( 2 )$$

$$Enc ( {m}_{3} ) = {Enc ( 1.5 )}^{1} + Enc {( 2 )}^{0} + Enc {( 3.5 )}^{0} + Enc {( 5 )}^{0} + Enc {( 4 )}^{0} = Enc ( 1.5 )$$

$$Enc ( {m}_{4} ) = Enc {( 1.5 )}^{0} + Enc {( 2 )}^{0} + Enc {( 3.5 )}^{0} + Enc {( 5 )}^{1} + Enc {( 4 )}^{0} = Enc ( 5 )$$

The processing device PD may then compute Enc(m−B)=Enc(p), by applying equ. 3.

$$Enc ( {p}_{1} ) = Enc ( {m}_{1} - {B}_{1} ) = Enc ( 3.5 - 3 ) = Enc ( 0.5 )$$

$$Enc ( {p}_{2} ) = Enc ( {m}_{2} - {B}_{2} ) = Enc ( 2 - 5 ) = Enc ( - 3 )$$

$$Enc ( {p}_{3} ) = Enc ( {m}_{3} - {B}_{3} ) = Enc ( 1.5 - 1.2 ) = Enc ( 0.3 )$$

$$Enc ( {p}_{4} ) = Enc ( {m}_{4} - {B}_{4} ) = Enc ( 5 - 3 ) = Enc ( 2 )$$

Random numbers r₁, r₂, r₃, r₄ may then be applied to Enc(p) by the processing device PD, by applying equ. 4, to obtain the processed ciphertext:

$$( {( Enc ( 3.5 ) \times Enc {( 3 )}^{- 1} )}^{{r}_{1}} , {( Enc ( 2 ) \times Enc {( 5 )}^{- 1} )}^{{r}_{2}} , {( Enc ( 1.5 ) \times Enc {( 1.2 )}^{- 1} )}^{{r}_{3}} , {( Enc ( 5 ) \times Enc {( 3 )}^{- 1} )}^{{r}_{4}} )$$

The processing device PD may then apply a random permutation, to obtain:

$$( {( Enc ( 2 ) \times Enc {( 5 )}^{- 1} )}^{{r}_{2}} , {( Enc ( 3.5 ) \times Enc {( 3 )}^{- 1} )}^{{r}_{1}} , {( Enc ( 5 ) \times Enc {( 3 )}^{- 1} )}^{{r}_{4}} , {( Enc ( 1.5 ) \times {Enc ( 1.2 )}^{- 1} )}^{{r}_{3}} )$$

The processing device PD may transmit the processed ciphertext to the client device CD.

The client device CD may obtain (step 104) the processed ciphertext from the processing device PD and decrypt (step 105) the processed ciphertext, to obtain a processed plaintext:

$$\begin{matrix}p = ( ( 2 - 5 ) \times {r}_{2} , ( 3.5 - 3 ) \times {r}_{1} , ( 5 - 3 ) \times {r}_{4} , ( 1.5 - 1.2 ) \times {r}_{3} ) \\ = ( - 3 \times {r}_{2} , 0.5 \times {r}_{1} , 2 \times {r}_{4} , 0.3 \times {r}_{3} )\end{matrix}$$

The client device CD may set (step 106) elements of the processed plaintext with a positive sign or being equal to 0 to 1 (first value), and elements of the processed plaintext with a negative sign to 0 (second value). The processed plaintext is p=(0, 1, 1, 1).

The client device CD may then encrypt (step 107) the processed plaintext p, to obtain a second ciphertext Enc(p)=(Enc(0), Enc(1), Enc(1), Enc(1)).

The client device CD may transmit (step 108) the second ciphertext to the processing device PD.

The processing device PD may apply to the second ciphertext a permutation inverse to the permutation applied to the processed ciphertext. Like this, the original order of the elements is recovered: (Enc(1), Enc(0), Enc(1), Enc(1)).

The processing device PD may determine, based on the second ciphertext Enc(p)=(Enc(1), Enc(0), Enc(1), Enc(1)) and the second matrix C, the encryption Enc(p×C)=Enc(q), by applying equ. 2 (q is referred to as fourth vector).

The processing device PD obtains:

$$Enc ( {q}_{1} ) = Enc {( 1 )}^{1} + Enc {( 0 )}^{1} + Enc {( 1 )}^{0} + Enc {( 1 )}^{0} = Enc ( 1 )$$

$$Enc ( {q}_{2} ) = Enc {( 1 )}^{1} + Enc {( 0 )}^{- 1} + Enc {( 1 )}^{0} + Enc {( 1 )}^{1} = Enc ( 2 )$$

$$Enc ( {q}_{3} ) = Enc {( 1 )}^{1} + Enc {( 0 )}^{- 1} + Enc {( 1 )}^{0} + Enc {( 1 )}^{- 1} = Enc ( 0 )$$

$$Enc ( {q}_{4} ) = Enc {( 1 )}^{- 1} + Enc {( 0 )}^{0} + Enc {( 1 )}^{1} + Enc {( 1 )}^{0} = Enc ( 0 )$$

$$Enc ( {q}_{5} ) = Enc {( 1 )}^{- 1} + Enc {( 0 )}^{0} + Enc {( 1 )}^{- 1} + Enc {( 1 )}^{0} = Enc ( - 2 )$$

The processing device PD may then compute a second processed ciphertext Enc(q−D), by applying equ. 3.

$$Enc ( {q}_{1} - {D}_{1} ) = Enc ( 1 - 2 ) = Enc ( - 1 )$$

$$Enc ( {q}_{2} - {D}_{2} ) = Enc ( 2 - 2 ) = Enc ( 0 )$$

$$Enc ( {q}_{3} - {D}_{3} ) = Enc ( 0 - 1 ) = Enc ( - 1 )$$

$$Enc ( {q}_{4} - {D}_{4} ) = Enc ( 0 - 1 ) = Enc ( - 1 )$$

$$Enc ( {q}_{5} - {D}_{5} ) = Enc ( - 2 - 0 ) = Enc ( - 2 )$$

Random numbers r₁, r₂, r₃, r₄, r₅ may then be applied by the processing device PD to the second processed ciphertext, by applying equ. 4, to obtain:

$$( {( Enc ( 1 ) \times Enc {( 2 )}^{- 1} )}^{{r}_{1}} , {( Enc ( 2 ) \times Enc {( 2 )}^{- 1} )}^{{r}_{2}} , {( Enc ( 0 ) \times Enc {( 1 )}^{- 1} )}^{{r}_{3}} , {( Enc ( 0 ) \times Enc {( 1 )}^{- 1} )}^{{r}_{4}} , {( Enc ( - 2 ) \times Enc {( 0 )}^{- 1} )}^{{r}_{5}} )$$

In addition, the processing device PD may apply a random permutation to the second processed ciphertext, to obtain:

$$( {( Enc ( - 2 ) \times Enc {( 0 )}^{- 1} )}^{{r}_{5}} ) , {( Enc ( 0 ) \times Enc {( 1 )}^{- 1} )}^{{r}_{4}} , {( Enc ( 0 ) \times Enc {( 1 )}^{- 1} )}^{{r}_{3}} , {( Enc ( 2 ) \times Enc {( 2 )}^{- 1} )}^{{r}_{2}} , {( Enc ( 1 ) \times Enc {( 2 )}^{- 1} )}^{{r}_{1}} ) .$$

The processing device PD may transmit the second processed ciphertext to the client device CD.

The client device CD may obtain (step 109) the second processed ciphertext from the processing device PD, and decrypt (step 110) the second processed ciphertext, to obtain a second plaintext:

$$( ( - 2 - 0 ) \times {r}_{5} , ( 0 - 1 ) \times {r}_{4} , ( 0 - 1 ) \times {r}_{3} , ( 2 - 2 ) \times {r}_{2} , ( 1 - 2 ) \times {r}_{5} )$$

The client device CD may set elements with a value different from 0 to 0 and elements with a value equal to 0 to 1.

The client device CD obtains:
(Enc(0), Enc(0), Enc(0), Enc(1), Enc(0))

The client device CD may then encrypt the second plaintext and transmit the encrypted second plaintext to the processing device PD.

The processing device PD may apply to the encrypted second plaintext a permutation inverse to the permutation applied to the second processed ciphertext to obtain a processed encrypted second plaintext. Like this, the original order of the elements is recovered.
(Enc(0), Enc(1), Enc(0), Enc(0), Enc(0))

The processing device PD may further multiply the encrypted second plaintext and a leaf vector by applying equ. 1 to obtain the encrypted outcome of the decision tree DT.

The leaf vector L=(L₁, L₂, L₃, L₄, L₅) may here be written as L=(1, 1, 0, 0, 0), where “1” stands for malicious and “0” stands for “begnin”.

When multiplying the encrypted second plaintext and the leaf vector, the encrypted outcome is Enc(1).

The processing device PD may transmit the encrypted outcome Enc(1) of the decision tree DT to the client device CD.

The client device CD may receive the encrypted outcome and decrypt it to determine (step 112) a leaf the outcome of the decision tree DT: 1 (which means “malicious”).

The proposed method 100 allows efficiently processing a plaintext to determine an outcome of the decision tree, without revealing the plaintext or the outcome of the decision tree to the processing device and without revealing the properties of the decision tree to the client device.

The only information that is publicly known is the structure of the decision tree, i.e. the number of nodes of the decision tree, and the number of elements of the input vector and the number of bits of each element of the input vector.

The client device CD cannot gather any relevant information about the decision tree DT, and the processing device PD cannot gather any relevant information about the plaintext or the outcome of the decision tree.

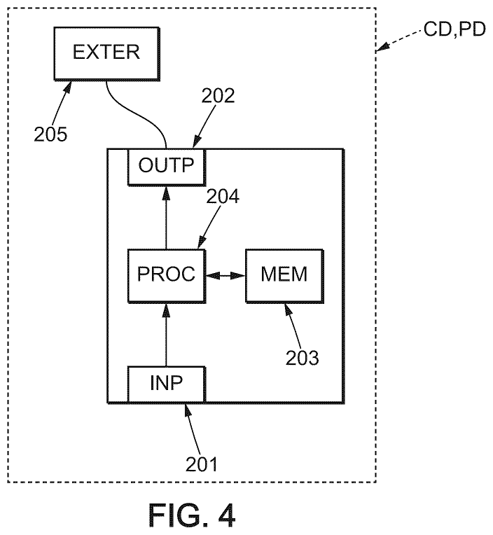

FIG. 4 shows a possible embodiment of a client device CD and a processing device PD configured to implement at least part of the method 100 described in relation to FIG. 3.

Each of the client device CD and the processing device PD may comprise at least one input interface 201 for receiving messages or instructions, and at least one output interface 202 for communicating with external devices 205.

In particular, the client device CD may be configured to transmit encrypted data to the processing device PD via its output interface 202, and to receive encrypted data from the processing device PD via its input interface 201.

The processing device PD may receive the encrypted data from the client device CD via its input interface 201 and transmit encrypted data to the client device CD via its output interface 202.

Each of the client device CD and the processing device PD may further comprise a memory 203 for storing instructions enabling the implementation of at least part of the method 100, the data received, and temporary data for carrying out the various operations of the method 100 as described above.

Each client device CD and processing device PD may further comprise one or more circuits 204, for example:
a processor able to interpret instructions in the form of a computer program, or
a circuit board in which the operations of the disclosed method 100 are described in the silicon, or
a programmable electronic chip such an FPGA chip (“Field-Programmable Gate Array”), an SOC (“System On Chip”), or an ASIC (“Application Specific Integrated Circuit”).

SOCs or systems on a chip are embedded systems that integrate all the components of an electronic system into a single chip. An ASIC is a specialized electronic circuit that groups customized functionalities for a given application. ASICs are generally configured during their manufacture and can be simulated by an operator of the client device CD and/or processing device PD. FPGA-type programmable logic circuits are electronic circuits that are reconfigurable by the operator of the client device CD and/or processing device PD.

Each step of the method 100 may be carried out by the same circuit or by an individual circuit.

The client device CD/processing device PD may be a computer, an electronic component, or another device comprising a processor operably coupled to a memory, as well as, depending on the chosen embodiment, a data storage unit, and other associated hardware elements such as a network interface and a media reader for reading removable storage media and for writing to such media.

Depending on the embodiment, the memory 203, the data storage unit, or the removable storage medium contain instructions which, when executed by circuit 204, cause this circuit to carry out or control the at least one input interface 201, the at least one output interface 202, the storage of data in memory 203, and/or the processing of data and/or the implementation of at least part of the method 100 according to FIG. 3. The circuit 204 may be a component which implements the control of the client device CD and/or processing device PD.

In addition, the client device CD and/or processing device PD may be implemented in software form, in which case it takes the form of a program executable by a processor, or in hardware form, such as an application specific integrated circuit ASIC, a system on chip SOC, or in the form of a combination of hardware and software elements, for example a software program intended to be loaded and executed on an electronic component described above such as an FPGA, processor.

The client device CD and/or processing device PD may also use hybrid architectures, for example architectures based on a CPU+FPGA, a GPU (“Graphics Processing Unit”), or an MPPA (“Multi-Purpose Processor Array”).

This disclosure is not limited to the example devices, systems, method, and computer program products described above solely by way of example, but encompasses all variants conceivable to the person skilled in the art within the framework of the protection sought.

What is claimed is:

1. A method for processing a digital content with a decision tree comprising a plurality of nodes and a plurality of leaves, wherein a splitting attribute and a splitting threshold are assigned to each node, the decision tree being defined by a first matrix defining a relation between the nodes and the splitting attributes, a second matrix defining a position of a respective leaf of the decision tree with respect to a respective node of the decision tree, a first vector comprising the splitting threshold of each node, and a second vector describing, for each leaf of the decision tree, a number of successful tests on splitting attributes of respective nodes required to reach a respective leaf, the method comprising:
obtaining, by a client device, a plaintext representative of a digital content to be processed, the plaintext being in the form of a vector;
encrypting, by the client device, the plaintext to obtain a ciphertext;
transmitting, by the client device, the ciphertext to a processing device;
obtaining, by the client device, a processed ciphertext from the processing device, the processed ciphertext being a function of an encryption of a difference between a third vector and the first vector, wherein an encryption of the third vector is determined based on an encryption of a multiplication of the plaintext and the first matrix;
decrypting, by the client device, the processed ciphertext, to obtain a processed plaintext;
setting, by the client device, elements of the processed plaintext with a positive sign or being equal to 0 to a first value and elements of the processed plaintext with a negative sign to a second value different from the first value;
encrypting, by the client device, the processed plaintext, to obtain a second ciphertext;
transmitting, by the client device, the second ciphertext to the processing device;
obtaining, by the client device, a second processed ciphertext from the processing device, the second processed ciphertext being a function of an encryption of a difference between a fourth vector and the second vector, wherein an encryption of the fourth vector is determined based on an encryption of a multiplication of the processed plaintext and the second matrix;
decrypting, by the client device, the second processed ciphertext, to obtain a second plaintext;
setting, by the client device, elements of the second plaintext either to a third value or to a fourth value, as a function of a value of a respective element of the second plaintext; and
determining, by the client device, an outcome of the decision tree based on the second plaintext, the outcome being representative of a leaf of the decision tree.

2. The method of claim 1, wherein a permutation is applied to the processed ciphertext by the processing device and a permutation inverse to the permutation applied to the processed ciphertext is applied to the second ciphertext by the processing device.

3. The method of claim 1, wherein a permutation is applied to the second processed ciphertext by the processing device, and wherein the method comprises:
having set elements of the second plaintext either to a third value or to a fourth value: encrypting, by the client device, the second plaintext;
transmitting, by the client device, the encrypted second plaintext to the processing device;
obtaining, by the client device, an encrypted outcome of the decision tree from the processing device, the encrypted outcome of the decision tree being representative of a leaf of the decision tree determined by the processing device by applying a permutation inverse to the permutation applied to the second processed ciphertext to the encrypted second plaintext, and by determining an encryption of a multiplication between the encrypted second plaintext and a leaf vector, wherein a respective element of the leaf vector is representative of a respective leaf of the decision tree; and
decrypting, by the client device, the encrypted outcome of the decision tree to obtain the outcome of the decision tree.

4. The method of claim 1, wherein encryption and decryption is based on a protocol being homomorphic with respect to addition and multiplication.

5. The method of claim 4, wherein the protocol is a Paillier encryption protocol.

6. The method of claim 5, wherein the encryption of a multiplication of the plaintext and the first matrix, and/or the encryption of a multiplication of the processed plaintext and the second matrix is defined as:
$$Enc ( {\sum }_{i} {a}_{i} {b}_{ij} ) = {\prod }_{i} Enc {( {a}_{i} )}^{{b}_{ij}}$$
wherein aᵢ are elements of the plaintext/the processed plaintext and bᵢⱼ are elements of the first matrix/the second matrix.

7. The method of claim 5, wherein the encryption of a difference between the third vector and the first vector and/or an encryption of a difference between the fourth vector and the second vector is defined as:
$$Enc ( {r}_{i} \times ( {c}_{i} - {d}_{i} ) ) = {( Enc ( {c}_{i} ) \times Enc {( {d}_{i} )}^{- 1} )}^{{r}_{i}}$$
wherein cᵢ are elements of the third vector/the fourth vector, dᵢ are elements of the first vector/the second vector, and rᵢ are numbers having a same sign.

8. The method of claim 7, wherein rᵢ are positive numbers.

9. The method of claim 7, wherein rᵢ are random numbers.

10. The method of claim 7, wherein the encryption of a difference between the third vector and the first vector and/or an encryption of a difference between the fourth vector and the second vector is defined as:
$$Enc ( {c}_{i} - {d}_{i} ) = Enc ( {c}_{i} ) \times Enc {( {d}_{i} )}^{- 1}$$

11. The method of claim 1, wherein each element of the second matrix is representative of a position of respective leaf with respect to a respective node of the decision tree, and wherein each element of the second matrix has a fifth value if a successful test of the splitting attribute of a respective node is required in order to reach the respective leaf, a sixth value if an unsuccessful test of the splitting attribute of the respective node is required in order to reach the respective leaf, and a seventh value it a respective leaf cannot be reached from a respective node.

12. A processing circuit comprising a processor and a memory, the memory storing program code instructions of a computer program, which, when the program code instructions are executed by the processor, cause the processor to execute the method of claim 1.

13. A client device configured to process a digital content with a decision tree comprising a plurality of nodes and a plurality of leaves, wherein a splitting attribute and a splitting threshold are assigned to each node, the decision tree being defined by a first matrix defining a relation between the nodes and the splitting attributes, a second matrix defining a position of a respective leaf of the decision tree with respect to a respective node of the decision tree, a first vector comprising the splitting threshold of each node, and a second vector describing, for each leaf of the decision tree, a number of successful tests on splitting attributes of respective nodes required to reach a respective leaf, the client device comprising:
an interface configured to obtain a plaintext representative of a digital content to be processed, the plaintext being in the form of a vector;
a circuit configured to encrypt the plaintext to obtain a ciphertext;
an interface configured to transmit the ciphertext to a processing device;
an interface configured to obtain a processed ciphertext from the processing device, the processed ciphertext being a function of an encryption of a difference between a third vector and the first vector, wherein an encryption of the third vector is determined based on an encryption of a multiplication of the plaintext and the first matrix;
a circuit configured to decrypt the processed ciphertext, to obtain a processed plaintext;
a circuit configured to set elements of the processed plaintext with a positive sign or being equal to 0 to a first value and elements of the processed plaintext with a negative sign to a second value different from the first value;
a circuit configured to encrypt the processed plaintext, to obtain a second ciphertext;
an interface configured to transmit the second ciphertext to the processing device;
an interface configured to obtain a second processed ciphertext from the processing device, the second processed ciphertext being a function of an encryption of a difference between a fourth vector and the second vector, wherein an encryption of the fourth vector is determined based on an encryption of a multiplication of the processed plaintext and the second matrix;
a circuit configured to decrypt the second processed ciphertext, to obtain a second plaintext;
a circuit configured to set elements of the second plaintext either to a third value or to a fourth value, as a function of a value of a respective element of the second plaintext; and
a circuit configured to determine an outcome of the decision tree based on the second plaintext, the outcome being representative of a leaf of the decision tree.

14. A processing device configured to process a digital content with a decision tree comprising a plurality of nodes and a plurality of leaves, wherein a splitting attribute and a splitting threshold are assigned to each node, the decision tree being defined by a first matrix defining a relation between the nodes and the splitting attributes, a second matrix defining a position of a respective leaf of the decision tree with respect to a respective node of the decision tree, a first vector comprising the splitting threshold of each node, and a second vector describing, for each leaf of the decision tree, a number of successful tests on splitting attributes of respective nodes required to reach a respective leaf, the processing device comprising:
an interface configured to receive a ciphertext from a client device, the ciphertext being determined by the client device by encrypting a plaintext, the plaintext being representative of a digital content to be processed, the plaintext being in the form of a vector;
a circuit configured to determine an encryption of a third vector equal to an encryption of a multiplication of the plaintext and the first matrix;
a circuit configured to determine a processed ciphertext function of an encryption of a difference between the third vector and the first vector;
an interface configured to transmit the processed ciphertext to the client device;
an interface configured to receive a second ciphertext from the client device, the second ciphertext being determined by the client device by decrypting the processed ciphertext to obtain a processed plaintext, by setting elements of the processed plaintext with a positive sign or being equal to 0 to a first value and elements of the processed plaintext with a negative sign to a second value different from the first value, and by encrypting the processed plaintext;
a circuit configured to determine an encryption of a fourth vector based on an encryption of a multiplication of the processed plaintext and the second matrix;
a circuit configured to determine a second processed ciphertext function of an encryption of a difference between a fourth vector and the second vector; and
an interface configured to transmit the second processed ciphertext to the client device, in order for the client device to decrypt the second processed ciphertext to obtain a second plaintext, to set elements of the second plaintext either to a third value or to a fourth value, as a function of a value of a respective element of the second plaintext, and to determine an outcome of the decision tree based on the second plaintext, the outcome being representative of a leaf of the decision tree.

15. A system comprising a client device of claim 13 and a processing device, the processing device comprising:
an interface configured to receive a ciphertext from the client device, the ciphertext being determined by the client device by encrypting a plaintext, the plaintext being representative of a digital content to be processed, the plaintext being in the form of a vector;
a circuit configured to determine an encryption of a third vector equal to an encryption of a multiplication of the plaintext and the first matrix;
a circuit configured to determine a processed ciphertext function of an encryption of a difference between the third vector and the first vector;
an interface configured to transmit the processed ciphertext to the client device;
an interface configured to receive a second ciphertext from the client device, the second ciphertext being determined by the client device by decrypting the processed ciphertext to obtain a processed plaintext, by setting elements of the processed plaintext with a positive sign or being equal to 0 to a first value and elements of the processed plaintext with a negative sign to a second value different from the first value, and by encrypting the processed plaintext;
a circuit configured to determine an encryption of a fourth vector based on an encryption of a multiplication of the processed plaintext and the second matrix;
a circuit configured to determine a second processed ciphertext function of an encryption of a difference between a fourth vector and the second vector; and
an interface configured to transmit the second processed ciphertext to the client device, in order for the client device to decrypt the second processed ciphertext to obtain a second plaintext, to set elements of the second plaintext either to a third value or to a fourth value, as a function of a value of a respective element of the second plaintext, and to determine an outcome of the decision tree based on the second plaintext, the outcome being representative of a leaf of the decision tree.
